(19) United States
(12) Patent Application Publication
(10) Pub. No.: US 2016/0232141 A1
(43) Pub. Date: Aug. 11, 2016

(54) DYNAMIC WEBSITE BUILDING SYSTEM

(71) Applicant: Fisher Printing, Inc., Orange, CA (US)

(72) Inventor: William Fischer, Orange, CA (US)

(21) Appl. No.: 15/134,270

(22) Filed: Apr. 20, 2016

Related U.S. Application Data
(63) Continuation of application No. 13/809,070, filed on Mar. 4, 2013.
(60) Provisional application No. 61/362,501, filed on Jul. 8, 2010.

(51) Int. Cl. G06F 17/22; G06F 17/30; G06F 3/0481; G06F 17/24; G06F 3/0484

(52) U.S. Cl. CPC G06F 17/2247; G06F 17/248; G06F 3/0484; G06F 3/0481; G06F 17/3089; G06F 17/30864

(57) ABSTRACT

A website development system is provided. The system includes a media database that is configured to allow for use of a plurality of different colors, images, and text within the website. In one embodiment, domain names may be searched for availability through a customizable search mechanism. Moreover, the system may add title tag and metatag information to help search engine keyword searches during development of the website. Additionally, the system may have a online support portion whereby support tickets may be utilized to help individual system users. The system may also utilize an online live chat help mechanism allowing for individualized help in the creation of the customized website.

### PRIORITY CLAIM

This application claims priority to the earlier filed U.S. patent application Ser. No. 13/809,070 filed Mar. 4, 2013; U.S. PCT Patent Application No. PCT/US2011/043421 filed Jul. 8, 2011 and U.S. Provisional Application No. 61/362,501 filed on Jul. 8, 2010, entitled “Dynamic Website Building System.”

### FIELD OF THE INVENTION

The field of the invention is for a website development system. More specifically, in some embodiments, the field of invention is for a dynamic website design and collection system which allows an individual to personalize and develop a website from an integrated system.

### BACKGROUND

Having a website has become an important aspect in selling goods and services in today's fast paced and competitive marketplace. Having a website that describes the goods and services and gives examples to potential customers of these goods and services can be the difference between a consumer contracting with one vendor and another.

The ability to build, utilize and customize a web page is very important to ongoing business development and advertising of goods and services. Typically these built websites, especially those that allow the individual vendor to build their own website, utilizes layouts for designing websites that assist people in quickly designing web pages for publishing to a web hosting server. These pre-programmed and layout website building systems offer very limited accessibility and customization. Typically, a user will utilize the building tool to build a standard, nondescript website with very limited ability to customize the website to the user's particular desires.

The alternative to utilizing these build it yourself type websites, is the use of a professional website developer. The professional website developer may give the owner greater flexibility as to what may be included and utilized on the website, but the control of the website, where it will be hosted and the like are all decided upon not by the owner, but rather by the website developer/designer. Additionally, the increased costs of hiring a developer/designer to design the website and then maintain it, can be cost prohibitive for many individual owners and/or small businesses.

One of the challenges in designing web page layouts where content may be customized by end users is that the size of the content or amount of text that may be inserted into the editable areas of the web page may vary from user to user. Because a web page generally provides a header area, a navigational area, and a bottom border around editable areas that may be customized by a user, the layout design required some knowledge of the size of the editable areas. Previously, this has caused layout providers to set a static size editable area, thereby limiting the amount of content that the user can insert in the editable areas.

Another challenge for the designers of web page layouts is the desirability of making web page themes work in all types of browsers.

Accordingly, it would be desirable to provide a web page generating tool that has a simple user interface and allows a web page designer to create flexible auto-expanding editable areas which grow and shrink based on the amount of content inserted into the editable areas, and to design themes that work in all browsers.

Therefore, a need exists for an improved website design system that dynamically allows the choice from a collection of web page layouts and themes to build a website. Additionally, a need exists for a website design system which allows for a choice of domain name selection, image libraries, linking systems, support response systems and other integrated abilities that are all part of the improved website design system.

### SUMMARY OF THE INVENTION

Embodiments of the disclosure relate to a dynamically integrated web development system that is configured so as to display and make available for editing a collection of web page layouts and themes that may be used in the development of a website. The system allows for use of a plurality of different colors, images, and text within the web development system and checks for availability of any particular domain name through a customizable search mechanism. The system is also configured so as to maintain one or more databases having a plurality of image libraries with the ability for the individual user to choose stored images, texts and the like, and the ability to download and/or upload customized text, images, and other data to the system for integration into the website. Moreover, the system may add title tag and metatag information to help search engine keyword searches during development of the website. Additionally, the system may have an online support portion whereby support tickets may be generated so as to assist individual system users. The system may also utilize online live chat systems and other similar mechanisms to provide individualized help in the creation of the customized website.

In one embodiment, a web development system and method is disclosed, wherein a collection of web page layouts and themes are made available for dynamic editing for use in the development of a website.

In an exemplary embodiment, a web page layout for customizing a web page in a web building tool, comprising: an auto-expanding user-editable content region having associated therewith an upper horizontal guide and a lower horizontal guide each of which horizontally intersects the auto-expanding user-editable content region; an outer background area; and an inner background.

In another exemplary embodiment, further comprising an auto-expanding navigational area which expands and contracts as navigation buttons are added and removed by an end user.

In another exemplary embodiment, wherein the outer background area comprises only a solid color, a repeated pattern, or a vertical gradient.

In another exemplary embodiment, wherein the inner background comprises only a solid color.

In another exemplary embodiment, wherein the auto-expanding user-editable content region allows only web-safe fonts.

In another exemplary embodiment, comprising at least one text area which can support non-web-safe fonts.

In another exemplary embodiment, wherein a size of text entered in the text area is determined using a Rich Text Editor, the web building tool automatically determining an amount to scale the current sized text to make the text the full width of the available text area, determining an amount to scale the current sized text to make the text the full height of the available text area, selecting the smaller of the horizontal scale and vertical scale, scaling the user-input text by the smaller selected scale, and replacing the user-input text in the text area with the scaled text.

In another exemplary embodiment, an HTML generation tool comprising: a processor; a memory configured to store instructions, the instructions causing the processor to generate an auto-expanding user-editable content region having associated therewith an upper horizontal guide and a lower horizontal guide each of which horizontally intersects the auto-expanding user-editable content region visible to a user at an output device, an outer background area visible to a user at an output device, and an inner background visible to a user at an output device; the instructions further causing the processor to generate HTML code based on user inputs relating to the auto-expanding user-editable content region, the outer background area, and the inner background.

In another exemplary embodiment, comprising a plurality of layouts and themes and instructions causing the processor to integrate one or more layout or theme into HTML code to build a website.

In another exemplary embodiment, comprising a centralized database including a plurality of colors, images, and text stored in the database for use by the individual user and further comprising instructions causing the processor to process incoming and outgoing information from an individual user and wherein the database includes an upload ability to allow a user to maintain an image library.

In another exemplary embodiment, comprising instructions causing the processor to check for availability of a domain name through a customized search mechanism which is integrated into the tool and instructions allowing an individual user to register a domain name through the system by checking through third party search mechanism and allowing for seamless registration through a third party domain name registrar.

In another exemplary embodiment, comprising a database having a plurality of image, text, audio, video and other media selections to be utilized by the individual website designer and may also allow for the ability to search online through the system for personalized and customized media to be uploaded into the system for the use with building the website.

In another exemplary embodiment, comprising a database with a plurality of digital media including images, text, video, audio and other media whereby the media may be accessed by the user to develop their customized website.

In another exemplary embodiment, further comprising instructions allowing for dynamically adding title tag and meta tag information to the HTML code to help search engine keyword searches.

In another exemplary embodiment, further comprising instructions for dynamic creation of contact pages whereby the website owner may receive emails and other types of communication through the personalized and customized website.

In another exemplary embodiment, comprising an online support mechanism to help individuals in development of their personalized website.

In another exemplary embodiment, wherein the online support mechanism allows a user to create an online support tickets and receive responses from the system to queries by the individual developer.

In another exemplary embodiment, further comprising including instructions for an online live chat system allowing the individual user to query the system for real-time answers to problems and/or questions encountered while developing their customized and personalized website.

In an exemplary embodiment, a computer-readable medium containing a set of instructions that causes a processor to: generate an auto-expanding user-editable content region having associated therewith an upper horizontal guide and a lower horizontal guide each of which horizontally intersects the auto-expanding user-editable content region visible to a user at an output device; generate an outer background area visible to a user at an output device, and an inner background visible to a user at an output device; generate code for a web page based on user inputs relating to the auto-expanding user-editable content region, the outer background area, or the inner background.

In another exemplary embodiment, comprising a collection of web page layouts and themes to be used in the development of an individual or business website; a database having a plurality of image libraries with the ability for the individual user to choose stored images, fonts, and the ability to download and/or upload customized fonts, images, and other data to the system for integration into the website.

In an exemplary embodiment, a dynamic website building system and method is provided whereby the system utilizes a plurality of layouts and themes to build a website.

In an exemplary embodiment, the dynamic website building system utilizes a plurality of web page layouts and themes to build a website.

In an exemplary embodiment, the dynamic website building system and method utilizes a plurality of information in a centralized database including a plurality of colors, images, and text stored in the database for use by the individual user.

In an exemplary embodiment, the dynamic website building system may have a centralized CPU which may process incoming and outgoing information from the individual user.

It is further contemplated that another exemplary embodiment is to provide a website building system whereby the system may check for availability of a domain name through a customized search mechanism which is integrated into the system.

Among the many different possibilities contemplated, the website building system and method allows an individual user to register a domain name through the system by checking through a third party search mechanism and allowing for seamless registration through a third party domain name registrar.

In an exemplary embodiment, a website building system is provided whereby the system may maintain an image library and upload ability to a user to maintain their own image library.

In still another exemplary embodiment, a website building system may be provided whereby the system may have a database having a plurality of image, text, audio, video and other media selections to be utilized by the individual website designer and may also allow for the ability to search online through the system for personalized and customized media to be uploaded into the system for the use with building the website.

In yet another exemplary embodiment, a website building system may be provided whereby the system may have a database with a plurality of digital media including images, text, video, audio and other media whereby the media may be accessed by the user to develop their customized website.

Yet another exemplary embodiment is to provide a website building system whereby the system may allow for dynamically adding title tag and metatag information to help search engine keyword searches.

Still another exemplary embodiment is to provide a website building system whereby the system may allow for dynamic creation of contact pages whereby the website owner may receive emails and other types of communication through the personalized and customized website.

Another exemplary embodiment is to provide a website building system whereby the system may have at least an online support mechanism to help individuals in development of their personalized website.

In another exemplary embodiment, a website building system is provided whereby the system may have at least an online support mechanism which allows the user to create online support tickets and receive responses from the system to queries by the individual developer.

Another exemplary embodiment is to provide a website building system whereby the system may have a online live chat system allowing the individual user to query the system for real-time answers to problems and/or questions encountered while developing their customized and personalized website.

Various objects, features, aspects and advantages of the present invention will become more apparent from the following detailed description of preferred embodiments of the invention, along with the accompanying drawings in which like numerals represent like components.

### BRIEF DESCRIPTION OF THE DRAWINGS

FIG. 1 illustrates a hardware implementation for a web development system in accordance with one embodiment as described herein.

FIG. 2 illustrates one embodiment of a layout of the web development system in accordance the systems and methods described herein.

FIG. 3 illustrates one embodiment of a system in an exemplary embodiment of the invention.

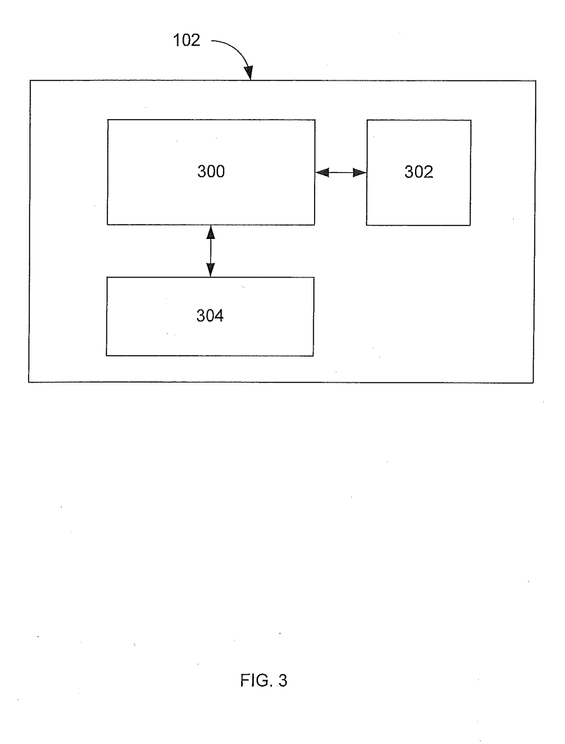

FIG. 4 illustrates an exemplary block diagram of logic associated with one embodiment of the web development system of FIG. 1.

### DETAILED DESCRIPTION

### I. Terminology

In the following description, certain terminology is used to describe features of the invention. For example, the term “computerized” generally represents that any corresponding operations are conducted by hardware in combination with software and/or firmware.

In certain situations, both terms “logic” and “engine” are representative of hardware, firmware and/or software that is configured to perform one or more functions. As hardware, logic (or engine) may include circuitry having data processing or storage functionality. Examples of such circuitry may include, but are not limited or restricted to a microprocessor, one or more processor cores, a programmable gate array, a microcontroller, an application specific integrated circuit, wireless receiver, transmitter and/or transceiver circuitry, semiconductor memory, or combinatorial logic. Logic (or engine) may be software in the form of one or more software modules, such as executable code in the form of an executable application, an application programming interface (API), a subroutine, a function, a procedure, an applet, a servlet, a routine, source code, object code, a shared library/dynamic load library, or one or more instructions. These software modules may be stored in any type of a suitable non-transitory storage medium, or transitory storage medium (e.g., electrical, optical, acoustical or other form of propagated signals such as carrier waves, infrared signals, or digital signals). Examples of non-transitory storage medium may include, but are not limited or restricted to a programmable circuit; a semiconductor memory; non-persistent storage such as volatile memory (e.g., any type of random access memory “RAM”); persistent storage such as non-volatile memory (e.g., read-only memory “ROM”, power-backed RAM, flash memory, phase-change memory, etc.), a solid-state drive, hard disk drive, an optical disc drive, or a portable memory device. As firmware, the executable code is stored in persistent storage.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps or acts are in some way inherently mutually exclusive.

### II. Web Development System

Embodiments described herein provide an integrated website development system that allows for collection of web page layouts and themes to be presented and used in the development of a website by generating relevant Hypertext Markup Language (HTML) code. It should be appreciated that HTML can include various HTML elements that generally feature tags. Tags normally come in pairs and are enclosed in angle brackets within the web page content. The first tag in a pair is the start or open tag, the second tag is the end or closing tag. In between these tags web designers can add text, tables, images, etc. Web browsers can be used to read HTML documents and compose them into visual or audible web pages. Rather than display the HTML tags, the web browser uses the tags to interpret the content of the page. XHTML (eXtensible Hypertext Markup Language) is a family of XML markup languages that mirror or extend versions of the widely-used Hypertext Markup Language (HTML), the language in which web pages are written.

In general, it is envisioned that in one embodiment, the systems and methods described herein may be configured so as to receive one or more user inputs, including textual and/or visual information so as to generate HTML code, XTML, Cascading Style Sheets (CSS), and the like that define the appearance and layout of the various textual and/or visual information.

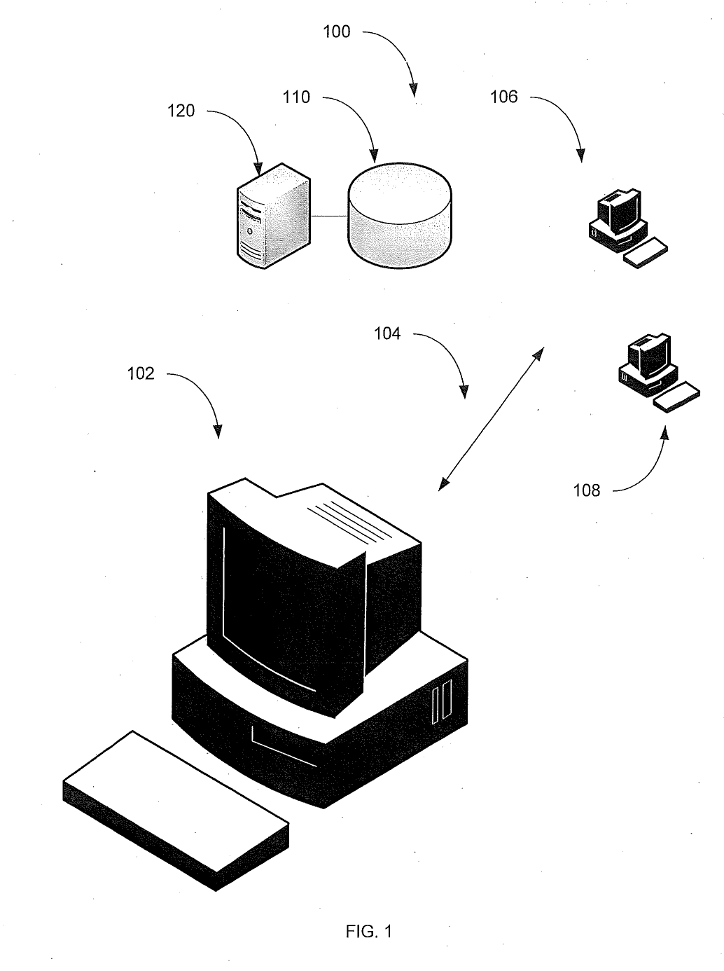

FIG. 1 illustrates one embodiment of a web development system 100 for dynamically integrated website generation in accordance with embodiments as described herein. The web development system 100 allows for a collection of web page layouts and themes to be implemented in the development of an individual or business website and may use a plurality of different colors, images, and text as appropriate. In one embodiment, the website being developed may generally be viewed on a monitor connected to a computer system 102 implementing aspects of the web development system 100. The web development system 100 may also maintain a database having a plurality of image libraries with the ability for the individual user to choose stored images, texts and the like, and the ability to download and/or upload customized text, images, and other data to the system for integration into the website. meta elements, such as a metatag, can include HTML elements that may be used to provide structured metadata about a Web page. Multiple elements may be used on the same page, e.g., the element being the same, but using different attributes. In an embodiment, the web development system 100 may add title tag and metatag information to help search engine keyword searches during development of the website.

Additionally, in one embodiment, the computer 102 may have an online, e.g., internet-based support connection 104 whereby support tickets may be generated to assist system 100 users. The web development system 100 may also utilize online 104 live chat help mechanism allowing for individualized help in the creation of the customized website. For example, a technical support person may chat with a person using the system 100 by connecting a computer 102 to a technical support computer 106 over the internet 104.

In one embodiment, the web development system 100 is configured to search and verify availability of a particular domain name through a customizable search mechanism. Such a customizable search mechanism might, for example, connect to one or more computers 108 over the internet 104. In one embodiment, the computers 108 may include a database of domain names which can be compared to a desired domain name. In some embodiments, when a searched domain name is already in the database domain similar available domain names can be generated by the computer 108 and transmitted back to the system 100 for review by a user. Additionally, the website building system 100 may allow an individual user to register a domain name through the system by checking through a third party search mechanism and allowing for seamless registration through a third party domain name registrar. It is further contemplated that another exemplary embodiment is to provide a website building system 100 whereby the system 100 may check for availability of a domain name through a customized search mechanism which is integrated into the computer 102. In other words, the check may be performed using information stored at a computer 102 rather than at the database 110 or server 120.

In one embodiment, the dynamic website building system and method utilizes a plurality of information stored in a centralized database 110 including, by way of non-limiting example, a variety of colors, images, and textual information available for selection and subsequent use by the user. In some embodiments the database 110 might be communicatively coupled to server 120 or otherwise configured as a network drive. It should be understood that the database 110 may be accessed over the internet 104 or other network or communication channel(s) on an as-needed basis.

The web development system 100 may maintain an image library as part of a media database 445 and also provide an upload capability so that the user can easily manage their own image library. The image library may be managed remotely, e.g., at server 120, at database 110, via network storage; or locally, e.g., on a storage device in or directly connected to computer 102. In one embodiment, the media database 445 is configured to store a plurality of digital media including images, text, video, audio and other media, such that the media may be accessed by the user to develop one or more websites.

In one embodiment, the website development system 100 is configured such that title tag and metatag information may be dynamically added to pertinent elements, including for example, images, tables and the like, so as to assist search engine keyword searches. It is envisioned that such an arrangement will desirably increase web traffic as elements of the website will be found and accessed at a greater rate. In one embodiment, the media database 445 may include pertinent logic to make the tag and metatag associations as discussed herein.

In one embodiment, the web development system 100 is configured so as to generate contact pages whereby the website owner may receive emails and other types of communication through the website. The contact page may include, for example, one or more email addresses, with a link to these email addresses and/or one or more postal addresses, telephone numbers, links to the web site owner's social networking information, etc.

In one embodiment, the web development system 100 features an online support mechanism configured to assist individuals in development of their personalized one or more websites. For example, the website development system 100 may have at least an online support mechanism which allows the user to generate online support tickets and receive responses thereto. The web development system 100 may have an online live chat system allowing the user to query the system 100 for real-time answers to problems and/or questions encountered while developing the website. For example, computer 102 may be connected to computer 108 over, e.g., the internet 104. A user of system 100 can then chat with a technical support person that may be using computer 108.

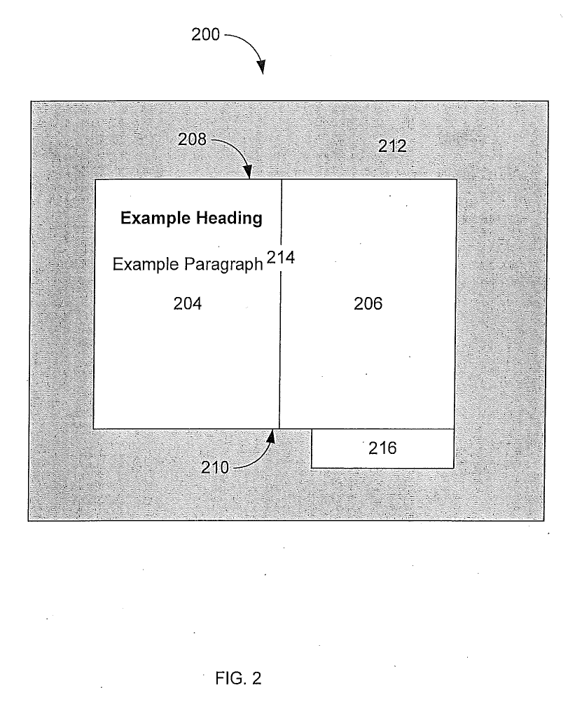

FIG. 2 illustrates exemplary graphical layout 200 and themes that may be utilized to build a website. A theme refers to the design of the web page and the organization between the elements. For example, different portions of a webpage may share the same or similar backgrounds, including colors, patterns, etc. The background might be tied in to other aspects of the web page, such as music or other media such as video content.

In one embodiment, layout 200 may be utilized so as to customize a web page in a web building tool. In an exemplary embodiment, the layout 200 includes an auto-expanding user-editable content region 204, 206 having associated therewith an upper horizontal guide 208 and a lower horizontal guide 210, wherein each of guides horizontally intersect the auto-expanding user-editable content region 204, 206. In one embodiment, the layout 200 may also feature an outer background area 212 and an inner background 214. It is envisioned that the inner background area 214 may provide background “underneath” text in one or more of the content regions. In an exemplary embodiment, the outer background area 212 may include only a solid color, a repeated pattern, or a vertical gradient. (A solid color, grey, is illustrated.) The inner background area might be only a solid color (e.g., white, as illustrated or another color) or a repeated pattern, or a vertical gradient, etc.

In general, when designing a website layout for a number of various users, the developer must consider at least, by way of non-limiting example, screen resolution, browser choice, whether or not the browser is maximized, and the operating system and hardware. Consequently, because so many factors are at play with respect to a particular web-site visitor's experience, and without a standardized system of web design, developers encounter a plurality of problems even after a web site is fully developed.

As such, it should be understood that conventional web layouts are considered to be substantially static, in that a fixed width is implemented with respect to various web elements. Moreover, conventional web layouts may be programmed so as to implement either static percentage widths or static widths (e.g., by pixel count). Consequently, using such a system, the screen resolution of the user does not matter, as the user will see the same width and/or height as other visitors.

In one exemplary embodiment, the auto-expanding user-editable content region 204 allows only web-safe fonts. In another exemplary embodiment, there will be at least one text area, e.g., user-editable content region 204, 206, which can support non-web-safe fonts. Additionally, in an exemplary embodiment, the web page layout 200 features an auto-expanding navigational area 216 that is configured so as to expand and contract as navigation buttons are added and removed by the user. It will also be understood that, while the illustrated embodiment includes two user-editable content region 204, 206 and one auto-expanding navigational area 216, the number of areas, and their respective locations may be varied depending on the application, without limitation.

In one embodiment, the size of text entered in the text area may be determined using a Rich Text Editor. The web building tool can automatically determine an amount to scale the current sized text to make the text the full width of the available text area, determine an amount to scale the current sized text to make the text the full height of the available text area, selecting the smaller of the horizontal scale and vertical scale, scaling the user-input text by the smaller selected scale, and replacing the user-input text in the text area with the scaled text.

A simple HTML example is provided below:

<html>
<body>
<h1>Example Heading</h1>
<p>Example paragraph.</p>
</body>
</html>

On a web browser the example HTML code can be a web page that has a heading “Example Heading” with a paragraph “Example Paragraph” below it. The systems and methods described herein allow a user to graphically develop a webpage and then generate, for example, HTML from that. Accordingly, after generating the document illustrated in FIG. 2 the simple HTML example above may be generated. Other HTML code will also be generated, e.g., for the grey outer background area 212. The white inner background area 214 might be a default, however, HTML code may be generated for other colors, patterns, etc. For example, a user may wish the inner background area 214 to match the outer background area 212, e.g., grey.

Additionally, while the example discussed above relates to the generation of HTML, it will be understood that the systems and methods described herein generally relate to generating a website, regardless of the type of code used. Accordingly, the systems and methods described herein may be applied to generate XHTML, Cascading Style Sheets (CSS) or other known or yet to be developed web page building blocks.

In one embodiment, the layout 200 features a relative unit of measurement to specify the width of the web page. Consequently, it is envisioned that the content of the web page resizes to adapt to the size of the browser window displaying it or the font used on the page. In one embodiment, the layout 200 features a hybrid scheme, wherein a combination of different units of measurement may be used so as to specify the width of various columns on the web page. Similarly, in one embodiment,

In one embodiment, the layout 200 utilizes one or more media queries to detect the width of the user's browser and alter the layout 200 accordingly. In one embodiment, the media queries may use CSS, although other formats and schemes may be used without limitation. As used herein, the media query may be implemented as an expression of logic. Thus, for example, in one embodiment, the layout 200 may provide a first query to the user's system, so as to determine the browser side. If the browser returns with a response of “500 pixels”, then the main content region may be set to display at, for example, 400 pixels wide. Similarly, if the browser responds with a response of 1000 pixel-width, then the main content region may be set to display at 960 pixel-width. Similarly, other regions beyond the main content region may change in width, height, swap locations, and/or be removed without limitation. For example, a multiple-column layout may become a single column layout or vice-versa, depending on the width of the user's browser.

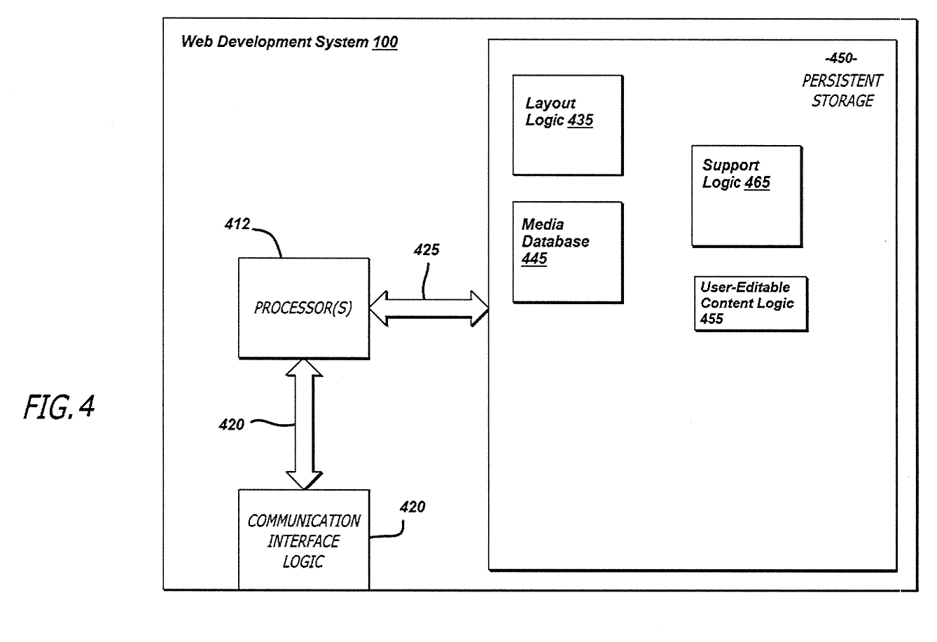

Referring now to FIG. 4, an exemplary block diagram of logic associated with the web development system 100 of FIG. 1 is shown. The web development system 100 comprises one or more processors 400 that are coupled to the communication interface logic 410 via a first transmission medium 420. Communication interface logic 410 enables communication with other web development systems. According to one embodiment of the disclosure, the communication interface logic 410 may be implemented as a physical interface including one or more ports for wired connectors. Additionally, or in the alternative, communication interface logic 410 may be implemented with one or more radio units for supporting wireless communications with other network devices.

In one embodiment, the web development system 100 may feature one or more processor(s) 400 is further coupled to the persistent storage 450 via the transmission medium 425. According to one embodiment of the disclosure, the persistent storage 430 may include (i) the media database 445, user-editable content logic 455, support logic 465 and layout logic 435. Of course, when implemented as hardware, one or more of these logic units could be implemented separately from each other.

For example, the user-editable content logic 455 of the persistent storage 450 may contain a set of instructions that causes a processor to generate an auto-expanding user-editable content region having associated therewith an upper horizontal guide and a lower horizontal guide each of which horizontally intersects the auto-expanding user-editable content region visible to a user at an output device. The instructions can also cause the processor to generate an outer background area visible to a user at an output device, and an inner background area visible to a user at an output device and generate code for a web page based on user inputs relating to the auto-expanding user-editable content region, the outer background area, or the inner background area.

In one embodiment, the layout logic 435 may also include a collection of web page layouts and themes to be used in the development of an individual or business website and a database having a plurality of image libraries with the ability for the individual user to choose stored images, and fonts. Some embodiments can also include an ability to download and/or upload customized fonts, images, and other data to the system for integration into the website.

In one embodiment, the support logic 465 may be configured to assist one or more users in development of a website, wherein online support tickets may be generated and responses received thereto.

The skilled artisan will recognize the interchangeability of various features from different embodiments. Similarly, the various features and steps discussed above, as well as other known equivalents for each such feature or step, can be mixed and matched by one of ordinary skill in this art to perform compositions or methods in accordance with principles described herein. Although the disclosure has been provided in the context of certain embodiments and examples, it will be understood by those skilled in the art that the disclosure extends beyond the specifically described embodiments to other alternative embodiments and/or uses and obvious modifications and equivalents thereof. Accordingly, the disclosure is not intended to be limited by the specific disclosures of embodiments herein.

What is claimed is:

1. A web development system comprising:
one or more processors;
a storage module communicatively coupled to the one or more processors, the storage module includes logic to generate:
a layout comprising an auto-expanding user-editable content region having associated therewith an upper horizontal guide and a lower horizontal guide, an outer background area visible to a user at an output device, and an inner background area visible to a user at an output device;
HTML code based on user inputs relating to the auto-expanding user-editable content region, the outer background area, and the inner background area;
an online support mechanism configured to assist a user in development of a personalized website, wherein the online support mechanism is configured to generate online support tickets and receive responses; and
an online live chat system configured so as to allow the user to query the system for real-time answers to at least one of a problem and question encountered while developing a personalized website.

2. The web development system of claim 1, further comprising any of a plurality of templates, themes, and instructions, causing the processor to integrate at least one templates or theme into HTML code to build a website.

3. The web development system of claim 1, further comprising a media database including a plurality of colors, images, and text stored therein for use by an individual user.

4. The web development system of claim 1, further comprising instructions causing the processor to check for availability of a domain name through a search mechanism.

5. The web development system of claim 1, further comprising instructions for dynamically adding title tag and metatag information to the HTML code to help search engine keyword searches.

6. The web development system of claim 1, further comprising instructions for dynamic creation of contact pages wherein a website owner may receive communications comprising emails through the personalized and customized website.
